(19) United States
(12) Patent Application Publication
(10) Pub. No.: US 2006/0290642 A1
(43) Pub. Date: Dec. 28, 2006

(54) Method of overdriving LCD device and overdriving circuit for LCD device

(75) Inventors: Seong-Gyun Kim, Seoul (KR); Hee-Jung Hong, Seoul (KR); Kyung-Joon Kwon, Seoul (KR)

Correspondence Address: BIRCH STEWART KOLASCH & BIRCH, PO BOX 747, FALLS CHURCH, VA, 22040-0747, US

(73) Assignee: LG. Philips LCD Co., Ltd.

(21) Appl. No.: 11/475,023

(22) Filed: Jun. 27, 2006

(30) Foreign Application Priority Data
Jun. 28, 2005 (KR) 10-2005-0056480

(51) Int. Cl. G09G 3/36

(52) U.S. Cl. 345/98

(57) ABSTRACT

An overdriving circuit for a liquid crystal display device, includes a system signal treating unit configured to treat an image data to generate a present frame data, a frame memory configured to store a former frame data used for treating the image data in the system signal treating unit, an overdriving unit configured to modulate the present frame data using the frame memory and a modulation data of a look-up table, and a liquid crystal panel configured to receive the modulated frame data and to display images.

The present application claims the priority benefit of Korean Patent Application No. 10-2005-0056480 filed in Korea on Jun. 28, 2005, which is hereby incorporated by reference.

### BACKGROUND OF THE INVENTION

1. Field of the Invention

The present invention relates to a liquid crystal display (LCD) device, and more particularly, to an overdriving circuit and method for an LCD device.

2. Discussion of the Related Art

An LCD device display images using optical anisotropy and polarization properties of liquid crystal molecules. Because the LCD device has a smaller size and lower power consumption than a display device using cathode-ray tubes (CRT), the LCD device has generally replaced the CRT. Also, because an active matrix LCD (AM-LCD) device including a thin film transistor (TFT) as a switching element has an advantage of displaying moving images, the AM-LCD device is widely used.

In addition, the LCD device includes first and second substrates facing each other with a liquid crystal layer interposed therebetween. The first substrate includes a TFT and a pixel electrode, and the second substrate includes a color filter and a common electrode. When a voltage is applied to the pixel electrode through the TFT, an electric field is formed between the pixel electrode and the common electrode. Then, an arrangement of the liquid crystal molecules and the amount of light transmitted are changed by the electric field and the LCD device displays images.

Further, because the liquid crystal molecules have an intrinsic viscosity and elasticity, the LCD device has a slow response rate. For example, because a twisted nematic (TN) mode LCD has a rising time between twenty and eighty seconds and a falling time between twenty and thirty seconds, a response time of the TN mode LCD is longer than a frame time. In addition, the rising time is a time that it takes for an applied voltage to reach a destination voltage and the falling time is a time that it takes the liquid crystal molecules to restore their elastic property. Accordingly, because a next frame starts before the applied voltage has reached the destination voltage, the display images appear blurred. This phenomenon is referred to as motion burring.

To resolve the above-mentioned problems, the response rate of the LCD device is compensated by modulating the image data. That is, when a highest mark of the former frame data and a highest mark of the present frame data are not equal, the image data is modulated using a modulation data corresponding to a difference between the highest marks of the former and present frame data. In addition, the modulation data is selected from a look-up table.

In more detail, FIG. 1 is a block diagram showing an overdriving circuit according to the related art. As shown in FIG. 1, the overdriving circuit includes a system signal treating unit 110, a liquid crystal panel 150, an electrically erasable and programmable read only memory (EEPROM) 154, a first frame memory 112 and a second frame memory 152. The system signal treating unit 110 receives image data and processes the data such as performing a contrast enhancement signal process, a deinterlacing process, etc. using a former frame data from the first frame memory 112, and then generates a present frame data representing red, green and blue colors. In addition, the first frame memory 112 stores the former frame data, and the system signal treating unit 110 uses the first frame memory 112 for treating the image data. Also, the first frame memory 112 is a synchronous dynamic random access memory (SDRAM).

Furthermore, the liquid crystal panel 150 receives the present frame data from the system signal treating unit 110 and the former frame data stored in the second frame memory 152. Then, the liquid crystal panel 150 compares the present frame data with the former frame data and modulates the signal data by selecting modulation data corresponding to a difference between the present and former frame data from the look-up table, and then displays images. Further, the EEPROM 154 stores the look-up table including the modulation data and the second frame memory 152 stores the former frame data. In addition, the look-up table has various kinds of the modulation data corresponding to characteristics of the liquid crystal panel 150. Generally, the modulation data stored in the look-up table is obtained by experiments.

However, because the liquid crystal panel 150 modulates the present frame data and then displays images, the liquid crystal panel 150 requires the second frame memory 152 and the EEPROM 154. Therefore, the production costs of the liquid crystal panel 150 increase.

### SUMMARY OF THE INVENTION

Accordingly, one object of the present invention is to address the above and other noted problems.

Another object of the present invention is to provide an overdriving device for an LCD that has an improved display quality without increasing a fabrication process and production cost.

To achieve these and other advantages and in accordance with the purpose of the present invention, as embodied and broadly described herein, the present invention provides an overdriving circuit for an LCD device, which includes a system signal treating unit configured to treat an image data to generate a present frame data, and a frame memory connected to the system signal treating unit. Further, the frame memory stores a former frame data used for treating the image data in the system signal treating unit. Also included is an overdriving unit configured to modulate the present frame data using the frame memory and a modulation data of a look-up table, and a liquid crystal panel configured to receive the modulated frame data and to display images.

In another aspect, the present invention provides a method of overdriving an LCD device, which includes treating an image data using a former frame data from a frame memory in a system signal treating unit to generate a present frame data, comparing the present frame data with the former frame data from the frame memory in the system signal treating unit, modulating the present frame data using modulation data of a look-up table in the overdriving unit, and displaying images using the modulated present frame data in a liquid crystal panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a block diagram showing an overdriving circuit according to the related art;

FIG. 2 is a block diagram showing an overdriving circuit according to the present invention; and

FIG. 3 is a flowchart of a method of overdriving an LCD device according to the present invention.

### DETAILED DESCRIPTION OF THE PREFERRED EMBODIMENTS

Reference will now be made in detail to the preferred embodiments, examples of which are illustrated in the accompanying drawings.

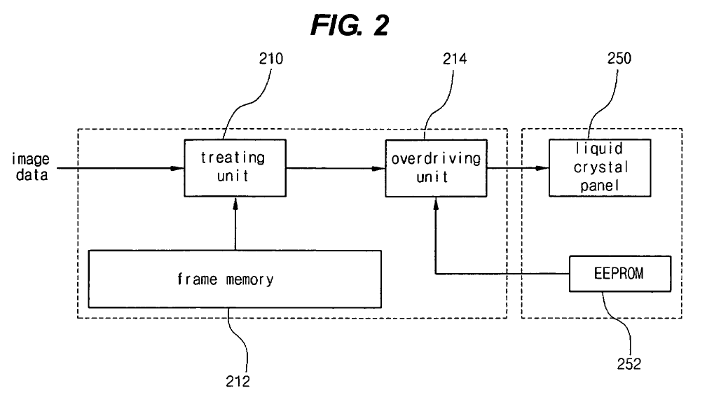

FIG. 2 is a block diagram showing an overdriving circuit according to the present invention. As shown in FIG. 2, the circuit includes a system signal treating unit 210, a frame memory 212, an overdriving unit 214, a liquid crystal panel 250 and an EEPROM 252. All the components of the circuit are operatively coupled. The system signal treating unit 210 receives an image data and performs treatments on the image data such as contrast enhancement, deinterlacing and so on, and then generates a present frame data representing red, green and blue colors. Further, the present frame data is then transferred to the overdriving unit 214. Also, the frame memory 212 stores a former frame data, and is used for treating the image data in the system signal treating unit 210 and for overdriving the present frame data in the overdriving unit 214. That is, the frame memory 212 storing the former frame data is connected to the system signal treating unit 210 and to the overdriving unit 214. In addition, the frame memory 212 is preferably a SDRAM.

The overdriving unit 214 then compares the present frame data with the former frame data. That is, the present frame data is output from the system signal treating unit 210, and the former frame data is stored in the frame memory 212. When there is a difference between the present and former frame data, the overdriving unit 214 selects a modulation data based on the difference from a look-up table and modulates the present frame data using the modulation data. Further, the overdriving unit 214 compares a highest mark of the present frame data with a highest mark of the former frame data. Then, the overdriving unit 214 outputs the modulated frame data. When there is no difference between the present and former frame data, the overdriving unit 214 maintains the present frame data.

In addition, the liquid crystal panel 250 receives the modulated frame data from the overdriving unit 214 and displays images. Also, the liquid crystal panel 250 includes first and second substrates and a liquid crystal layer (not shown). The first and seconds substrates face each other, and the liquid crystal layer is interposed therebetween. Further, the first substrate includes gate and data lines, which cross each other to define a pixel region, and a thin film transistor is formed at the crossing of the gate and data lines.

In addition, the EEPROM 252 is included in the liquid crystal panel 250 and stores the look-up table used for overdriving the LCD device. Also, the look-up table is sent to the overdriving unit 214 in a driving step of the LCD device. The look-up table has various kinds of the modulation data according to each different liquid crystal panel 250. The modulation data is generally obtained by experiments. Further, the frame memory 212 and the overdriving unit 214 are preferably included in the system signal treating unit 210, and the system signal treating unit 210 is integrated and as a single chip.

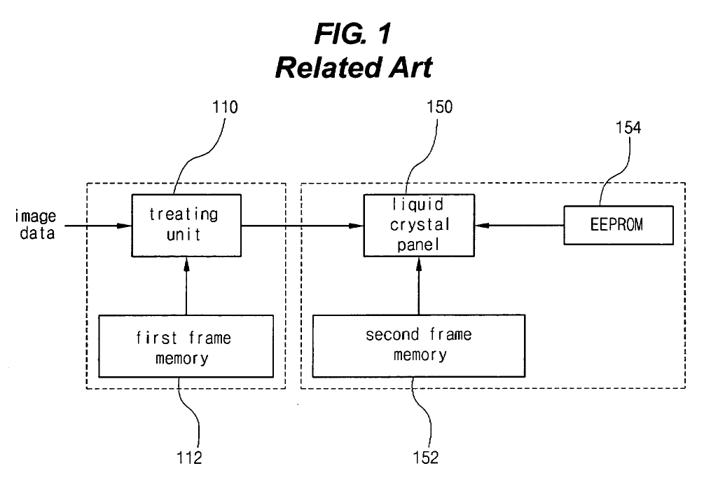

Unlike the related art, the above-mentioned overdriving circuit 214 uses the frame memory 212 for overdriving and does not include the second frame memory 152 of FIG. 1. Accordingly, production costs of the liquid crystal panel are decreased.

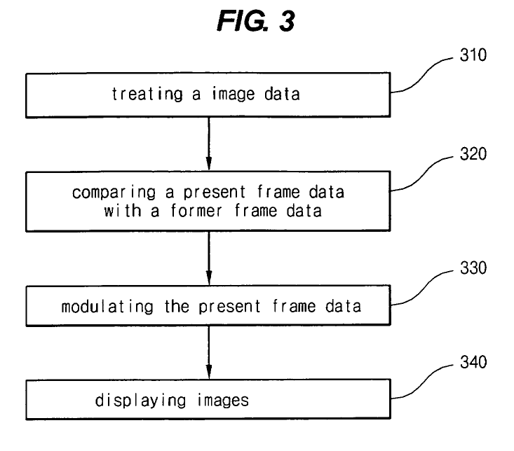

Turning next to FIG. 3, which is a flowchart illustrating a method of overdriving an LCD device according to the present invention. FIG. 2 will also be referred to in this description. As shown in FIG. 3, the method includes treating the image data to generate a present frame data (S310), comparing the present frame data with a former frame data (S320), modulating the present frame data (S330), and displaying the image using the modulated frame data (S340). Further, as discussed above, when treating the image data, the system signal treating unit 210 of FIG. 2 receives the image data and performs treatment of the image data using the former frame data from the frame memory 212, and then generates the present frame data representing the red, green and blue colors. The treatment of the image data includes contrast enhancement, deinterlacing and so on, and the present frame data is transferred to the overdriving unit 214.

In addition, when comparing the present and former frame data, the overdriving unit 214 receives the former frame data from the frame memory 212 directly or via the system signal treating unit 210 and the present frame data from the system signal treating unit 210, and then compares the present frame data with the former frame data. When there is a difference between the present and former frame data, the overdriving unit 214 selects the modulation data corresponding to the difference from the look-up table. In addition, the overdriving unit 214 compares the highest mark of the present frame data with the highest mark of the former frame data.

Then, the overdriving unit 214 modulates the present frame data using the modulation data, and outputs the modulated present frame data to the liquid crystal panel 250. When there is no difference between the present and former frame data, the overdriving unit 214 maintains the present frame data. Further, the frame memory 212 can be included in the system signal treating unit 210 and is used for treating the image data and comparing the present and former frame data. Also, as discussed above, the look-up table has various kinds of the modulation data corresponding to the characteristics of the particular liquid crystal panel, and the modulation data are obtained by experiments, for example. In addition, when displaying the images, the liquid crystal panel 250 receives the modulated frame data from the overdriving unit 214 and displays the images.

As mentioned above, in the method of overdriving the LCD device according to the present invention, the liquid crystal panel receives the modulated frame data and displays images. In other words, treating the image data and overdriving the present frame data are performed in an exterior of the liquid crystal panel, and the liquid crystal panel only displays images. Unlike the method of overdriving according to the related art, the above-mentioned overdriving method only requires one frame memory. Accordingly, the costs of the liquid crystal panel decrease.

It will be apparent to those skilled in the art that various modifications and variations can be made in the substrate for the liquid crystal display device and the method of fabricating the same of the present invention without departing from the sprit or scope of the invention. Thus, it is intended that the present invention covers the modifications and variations of this invention provided they come within the scope of the appended claims and their equivalents.

What is claimed is:

1. An overdriving circuit for a liquid crystal display device, comprising:
a system signal treating unit configured to treat an image data to generate a present frame data;
a frame memory configured to store a former frame data used for treating the image data;
an overdriving unit configured to modulate the present frame data using the frame memory and a modulation data of a look-up table; and
a liquid crystal panel configured to receive the modulated frame data and to display images.

2. The overdriving circuit according to claim 1, wherein the frame memory is a synchronous dynamic random access memory (SDRAM).

3. The overdriving circuit according to claim 1, further comprising an electrically erasable and programmable read only memory (EEPROM) configured to store the look-up table.

4. The overdriving circuit according to claim 1, wherein the look-up table includes various modulation data corresponding to a difference between the present frame data and the former frame data.

5. The overdriving circuit according to claim 1, wherein the overdriving unit maintains the present frame data when the present frame data is substantially the same as the former frame data.

6. The overdriving circuit according to claim 1, wherein the liquid crystal panel displays the images without accessing a former frame data stored in a memory connected to the liquid crystal panel.

7. The overdriving circuit according to claim 1, wherein the system signal treating unit receives the former frame data from the frame memory, and outputs the received former frame data and the present frame data to the overriding unit.

8. A method of overdriving a liquid crystal display device, comprising:
treating an image data using a former frame data to generate a present frame data;
comparing the present frame data with the former frame data;
modulating the present frame data using modulation data; and
displaying images using the modulated present frame data.

9. The method according to claim 8, wherein the modulcating step modulates the present frame data when there is a difference between the present frame data and the former frame data as a result of the comparing step.

10. The method according to claim 9, further comprising selecting the modulation data corresponding to the difference between the present frame data and the former frame data from a look-up table.

11. The method according to claim 8, wherein the modulating step modulates the present frame data when there is the difference between a highest mark of the present frame data and a highest mark of the former frame data.

12. The method according to claim 8, wherein in the treating step, treating the image data includes at least one of contrast enhancement and deinterlacing.

13. The method according to claim 8, wherein the displaying step displays the images on a liquid crystal panel.

14. The method according to claim 13, wherein the displaying step displays the images on the liquid crystal panel without accessing a former frame data stored in a memory connected to the liquid crystal panel.

15. The method according to claim 8, wherein the comparing step is performed by an overdriving unit, and the former frame data used in the comparing step is stored in a frame memory connected to the overdriving unit.

16. An overdriving circuit for a liquid crystal display panel, the overdriving circuit comprising:
a signal treating unit to treat image data and generate present frame data;
a frame storage to store former frame data usable in treating the image data and supplying the former frame data to an overdriving unit; and
the overdriving unit to compare the present frame data received from the signal treating unit and the former frame data received from the frame storage, and to selectively modulate the present frame data based on the comparison result,
wherein the overdriving circuit is disposed at an exterior of the liquid crystal display panel.

17. The overdriving circuit according to claim 16, wherein the frame storage is a synchronous dynamic random access memory (SDRAM).

18. The overdriving circuit according to claim 16, wherein the overdriving unit modulates the present frame data using modulation data of a look-up table.

19. The overriding circuit according to claim 18, wherein the overdriving circuit further comprises an electrically erasable and programmable read only memory (EEPROM) configured to store the look-up table.

20. The overriding circuit according to claim 18, wherein the look-up table includes various modulation data corresponding to a difference between the present frame data and the former frame data.
